(19) United States
(12) Patent Application Publication
(10) Pub. No.: US 2010/0196671 A1
(43) Pub. Date: Aug. 5, 2010

(54) POLYMERIC COMPOSITE ARTICLE AND METHOD OF MAKING THE SAME

(75) Inventors: James P. Sorensen, Eagan, MN (US); Timothy J. Gennrich, Fountain Hills, AZ (US); Duane M. Hart, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/363,874

(22) Filed: Feb. 2, 2009

(51) Int. Cl. F41H 5/04; B29C 70/16

(52) U.S. Cl. 428/174; 156/166; 428/702; 428/698; 428/469

(57) ABSTRACT

Article comprising a monolithic ceramic layer and a polymeric composite layer and method of making is described. The article may be useful, for example, as armor.

### TECHNICAL FIELD

This disclosure broadly relates to articles comprising a monolithic ceramic layer and a polymeric composite and to methods of making the same. Articles of the present disclosure may be used in anti-ballistic armor.

### BACKGROUND

High performance armor designed to resist armor piercing projectiles or fragments typically are made up of more than one component with each component serving a different primary function. For example, armor designed to resist armor piercing typically has a first component (generally a hard component) and a second component (generally an energy absorbing component).

The hard component, which is usually made of very hard materials is commonly used as the strike face to blunt, fracture, abrade, shatter or deflect the projectile. Because of their high hardness and high compression strength, ceramics tend to be more effective than metals in resisting such penetrations, but because of their brittle nature are not as resistant to multiple hits at close spacing. Typically, a monolithic ceramic plate 0.375 inch (9.5 mm) thick is required to successfully abrade, break, blunt or deflect an armor piercing 30-caliber bullet (National Institute of Justice Standard 0108.01 Type IV test). To increase the resistance of the monolithic ceramic to penetration, a residual compression stress may be applied to the monolithic ceramic via a metal alloy as described in U.S. Pat. No. 4,760,611 (Huet, et al.).

### SUMMARY

In one aspect, the present disclosure provides an article comprising a monolithic ceramic comprising at least two major surfaces and at least one minor surface; and a polymeric composite comprising at least one of continuous fibers that have an MCD, defined as specific modulus*coefficient of thermal expansion/density, of greater than 220,000 ((N/m2)/(g/mL))*(1/° C.), wherein the polymeric composite is fixedly attached to the at least two major surfaces and the polymeric composite is fixedly attached to a surface area of each of the at least two major surfaces that is substantially greater than a surface area of the at least one minor surface.

In some embodiments, the polymeric composite comprises the at least one of continuous fibers in a polymer wherein the polymer cures or solidifies at a temperature above 22° C.

In some embodiments, the polymeric composite fixedly attached to the at least two major surfaces is substantially symmetrical along the longitudinal bisection of the monolithic ceramic.

In some embodiments, the at least one of continuous fibers of the polymeric composite comprise at least one of: ceramic, boron, or combinations thereof.

In another aspect, the present disclosure provides a method of making an article comprising providing a monolithic ceramic comprising at least two major surfaces and at least one minor surface and a polymeric composite comprising at least one of continuous fibers that have an MCD of greater than 220,000 ((N/m2)/(g/mL))*(1/° C.); and fixedly attaching the polymeric composite to the at least two major surfaces wherein a surface area of each of the at least two major surfaces is substantially greater than a surface area of the at least one minor surface.

Optionally, embodiments of articles according to the present disclosure may further comprise at least one of a catcher (i.e., a separate energy and/or fragment catching layer) and/or metal layers.

Articles according to the present disclosure may be useful, for example, as armor for individuals, vehicles, equipment, etc.

Advantageously, these novel articles may offer improved performance and/or properties and may provide manufacturing advantages.

The above summary is not intended to describe each embodiment. The details of one or more embodiments of the disclosure are also set forth in the description below. Other features, objects, and advantages will be apparent from the description and from the claims.

### BRIEF DESCRIPTION OF DRAWINGS

FIG. 1 is a schematic side view of exemplary article 10 according to one aspect of the present disclosure.

FIG. 2 is a schematic side view of exemplary article 20 according to one aspect of the present disclosure.

FIG. 3 is a schematic side view of exemplary article 50 depicting the imaginary longitudinal bisection of the monolithic ceramic.

FIG. 4 is a schematic side view of exemplary armor 80 according to one aspect of the present disclosure.

### DETAILED DESCRIPTION

As used herein, the term

“a”, “an”, “the”, and “at least one of” are used interchangeably and mean one or more; and

“and/or” is used to indicate one or both stated cases may occur, for example A and/or includes, (A and B) and (A or B).

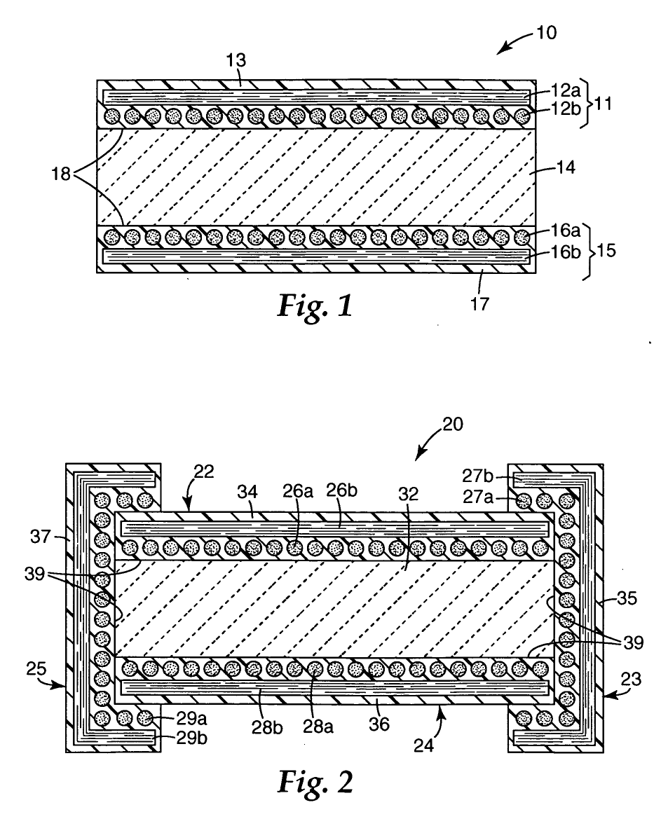

FIG. 1 depicts one exemplary embodiment of the present disclosure. Article 10 comprises first polymeric composite layer 11, monolithic ceramic layer 14, and second polymeric composite layer 15, fixedly attached with polymer 18. First polymeric composite layer 11 comprises continuous fibers 12a and 12b, and polymer 13, wherein continuous fibers 12a are offset 90° with respect to 12b. Second polymeric composite layer 15 comprises continuous fibers 16a and 16b and polymer 17, wherein continuous fibers 16a are offset 90° with respect to 16b.

Although not wanting to be bound by theory, it is believed that the polymeric composite layers (e.g., first polymeric composite layer 11 and second polymeric composite layer 15) provide among other things, residual compression of the monolithic ceramic layer. The polymeric composite layers may also provide containment of the monolithic ceramic layer following a ballistic impact, such as a bullet.

Residual compressive stress in the monolithic ceramic may be imparted by the adjacent polymeric composite layers. The amount of residual compressive stress applied to the monolithic ceramic is related to the coefficient of thermal expansion (CTE) and the elastic stiffness (high Young's modulus) of the polymeric composite as compared to the monolithic ceramic. Additionally, the polymeric composite layers may also provide improved bending stiffness of the article. The relatively high elastic stiffness (Young's modulus) of the polymeric composite layers, combined with their location at the surfaces of the monolithic ceramic (preferably as far from the bending neutral axis as possible) means that in some embodiments the polymeric composite layers may efficiently improve the bending stiffness of the monolithic ceramic (i.e., more improvement at less added weight). Reducing the bending deflection of the monolithic ceramic, and increasing the dwell time of the projectile or fragment in the monolithic ceramic may improve the ballistic performance of the ceramic (i.e., makes it more effective in abrading, fracturing, blunting, and/or deflecting projectiles or fragments).

Although not wanting to be bound by theory, in the present disclosure it is believed that the continuous fibers of the polymeric composite are responsible for a majority of the residual compression imparted on the monolithic ceramic. In the present disclosure, an MCD value is used to evaluate the fibers. The MCD value is a calculated value obtained by multiplying the specific modulus of the fiber times the CTE of the fiber divided by the density of the fiber. The units for MCD are represented by ((N/m²)/(g/mL))*(1/° C.), where N is Newtons, m is meters, g is grams, mL is milliliters, and C is Celsius. The density, specific modulus, and CTE were taken from product literature for various fibers and the MCD was calculated and is shown in Table 1 below.

TABLE 1

| | | Specific | CTE | MCD |
|---|---|---|---|---|
| | Density | Modulus | (×10⁶) | ((N/m²)/ |
| Fiber | (g/mL) | (×10¹⁰) (N/m²) | (1/° C.) | (g/mL)) * (1/° C.) |
| Aramid | 1.44 | 8.86 | −6 | −530,000 |
| T-650 Carbon* | 1.7 | 14.6 | −0.6 | −90,000 |
| IM7 Carbon* | 1.8 | 15.3 | 0 | 0 |
| E-glass | 2.57 | 2.68 | 5 | 130,000 |
| Nextel 312* | 2.7 | 5.62 | 3 | 170,000 |
| S-glass* | 2.49 | 3.60 | 5.4 | 190,000 |
| SiC Nicalon* | 2.3 | 8.09 | 3.1 | 250,000 |
| SiC Hi Nicalon* | 3.1 | 13.6 | 3.1 | 420,000 |
| Boron | 2.57 | 15.6 | 4.5 | 700,000 |
| Nextel 610* | 3.9 | 9.90 | 7.9 | 780,000 |

*T-650 are fibers made from a polyacrylonitrile precursor sold under the trade designation “CYTEC THORNEL” by Cytec Industries Inc., West Paterson, NJ; IM7 Carbon are carbon fibers sold under the trade designation “HEXCEL IM7 CARBON FIBER” by Hexcel Corp., Dublin, CA; Nextel 312 are alumina-boria-silica fibers sold under the trade designation “3M NEXTEL CERAMIC OXIDE FIBER 312” by 3M Co., St. Paul, MN; S-glass fibers, for example, sold under the trade designation “S2-Glass Fiber” by AGY Holding Corp., Aiken, SC; SiC Nicalon are silicon-carbon fibers sold under the trade designation “NICALON SiC FIBER” by COI Ceramics, Inc., San Diego, CA; SiC Hi Nicalon are higher purity ceramic fibers sold under the trade designation “HI NICALON CERAMIC FIBER” by COI Ceramics, Inc.; and Nextel 610 are alumina fibers sold under the trade designation “3M NEXTEL CERAMIC NONWOVEN 610” by 3M Co.

By appropriately selecting the continuous fiber in the polymeric composite and the monolithic ceramic, the polymeric composite may not only contain the monolithic ceramic, but also apply residual compression stress to the monolithic ceramic. For example, fiberglass (such as E-glass or S-Glass) has a higher CTE than most monolithic ceramics, but the specific modulus is so low that the residual compression induced is low. On the other hand, carbon fibers such as T-650 and IM7 listed in Table 1, have a high specific modulus, but have a low CTE so they do not produce residual compression. Aramid fibers, which are used extensively in ballistic applications, do not produce residual compression, but in fact may have the opposite effect, i.e., they create residual tension in the monolithic ceramic, because they have a negative CTE. Traditionally, residual compression stress is thought to improve the ballistic performance of ceramics, whereas residual tension stress is thought to have the opposite effect (i.e., degrade the ballistic performance of the ceramic).

Suitable continuous fibers of this present disclosure have an MCD value of greater than 220,000, greater than 400,0000, greater than 600,000, or even greater than 750,000 ((N/m²)/(g/mL))*(1/° C.).

In one embodiment, the polymeric composite comprises continuous fiber with an MCD greater than 220,000 ((N/m²)/(g/mL))*(1/° C.) and continuous fiber with an MCD less than 220,000 ((N/m²)/(g/mL))*(1/° C.). One motivation to provide such a polymeric composite is because NICALON SiC FIBER, HI NICALON CERAMIC FIBER, boron fiber and 3M NEXTEL CERAMIC NONWOVEN 610 are typically more expensive fibers. Therefore, continuous fiber with an MCD greater than 220,000 ((N/m²)/(g/mL))*(1/° C.) may be used to provide the residual compression, while a less expensive continuous fiber with an MCD less than 220,000 ((N/m²)/(g/mL))*(1/° C.) may be used to provide containment.

Examples of suitable continuous fibers having an MCD of greater than 220,000 N mL ° C./(m² g) include ceramic fibers (e.g., ceramic oxides, silicon carbide, and alumina fibers), boron fibers (e.g., boron nitride, and boron carbide), or combinations thereof. Typically, the ceramic fibers are crystalline ceramics (i.e., exhibits a discernible X-ray powder diffraction pattern) and/or a mixture of crystalline ceramic and glass (i.e., a fiber may contain both crystalline ceramic and glass phases), although they may also be glass. In some embodiments, the fiber is at least 50 (in some embodiments, at least 55, 60, 65, 70, 75, 80, 85, 90, 95, 96, 97, 98, 99, or even 100) percent by weight crystalline. Examples of suitable crystalline ceramic oxide fibers include refractory fibers such as alumina fibers, aluminosilicate fibers, aluminoborate fibers, aluminoborosilicate fibers, zirconia-silica fibers, or combinations thereof.

Some embodiments of the ceramic oxide fibers comprise at least 40 (in some embodiments, at least 50, 60, 65, 70, 75, 80, 85, 90, 95, 96, 97, 98, 99, or even 100) percent by volume Al₂O₃, based on the total volume of the fiber. In some embodiments, it is desirable for the fibers to comprise in a range from 40 to 70 (in some embodiments, in a range from 55 to 70, or even 55 to 65) percent by volume Al₂O₃, based on the total volume of the fiber.

Alumina fibers are described, for example, in U.S. Pat. Nos. 4,954,462 (Wood et al.) and 5,185,299 (Wood et al.). In some embodiments, the alumina fibers are polycrystalline alpha alumina fibers, and comprise, on a theoretical oxide basis, greater than 99 percent by weight Al₂O₃ and 0.2-0.5 percent by weight SiO₂, based on the total weight of the alumina fibers. In another aspect, some desirable polycrystalline, alpha alumina fibers comprise alpha alumina having an average grain size of less than 1 micrometer (or even, in some embodiments, less than 0.5 micrometer). Exemplary alpha alumina fibers are marketed under the trade designation “NEXTEL 610” by 3M Co.

Aluminosilicate fibers are described, for example, in U.S. Pat. No. 4,047,965 (Karst et al). Exemplary aluminosilicate fibers are marketed under the trade designations “NEXTEL 440”, “NEXTEL 550”, and “NEXTEL 720” by 3M Co.

Aluminumborate and aluminoborosilicate fibers are described, for example, in U.S. Pat. No. 3,795,524 (Sowman).

Zirconia-silica fibers as described, for example, in U.S. Pat. No. 3,709,706 (Sowman).

Typically, the continuous ceramic fibers have an average fiber diameter of at least 5, 7, or 10 micrometers; and at most 10, 15 or 20 micrometers.

Typically, the ceramic fibers are provided in tows. Tows are known in the fiber art and typically include a plurality of (individual) generally untwisted fibers (typically at least 100 fibers, more typically at least 400 fibers). In some embodiments, tows comprise at least 780 individual fibers per tow, and in some cases, at least 2600 individual fibers per tow, or at least 5200 individual fibers per tow. Tows of various ceramic fibers are available in a variety of lengths, including 300 meters, 500 meters, 750 meters, 1000 meters, 1500 meters, and longer. The fibers may have a cross-sectional shape that is circular, elliptical, or dogbone.

Exemplary boron fibers include: boron monofilament fibers and composites such as boron nitride and boron carbide. Such fibers are commercially available, for example, from Specialty Materials, Inc. of Lowell, Mass. and Advanced Ceramics Inc., Vista Calif. Typically, the continuous boron fibers have a length on the order of at least 50 meters, and may even have lengths on the order of kilometers or more. Typically, the continuous boron fibers have an average fiber diameter in a range from 80 micrometers to 200 micrometers. More typically, the average fiber diameter is no greater than 150 micrometers, most typically in a range from 95 micrometers to 145 micrometers.

Exemplary silicon carbide fibers are sold, for example, under the trade designation “NICALON” in tows of 500 fibers by COI Ceramics of San Diego, Calif.; under the trade designation “TYRANNO” by Ube Industries of Japan; and under the trade designation “SYLRAMIC” by Dow Corning of Midland, Mich.

Exemplary silicon carbide monofilament fibers are sold, for example, under the trade designations “SCS-9”, “SCS-6”, and “Ultra-SCS” by Specialty Materials, Inc., Lowell, Mass.

Typically, at least 70, 75, 80, 85, or 90% by number of the fibers in the elongated polymeric composite are substantially continuous (i.e., having a length that is relatively infinite when compared to the average fiber diameter). In some embodiments, and typically, the fibers are longitudinally positioned (i.e., the fibers are oriented in the same direction) and held together to form a laminate or sheet. In some embodiments, it is desirable that all of the continuous fibers are maintained in an essentially longitudinally aligned configuration where individual fiber alignment is maintained within ±10° (in some embodiments ±5°, or even ±3°) of their average longitudinal axis.

The number of layers of continuous fibers used in the polymeric composite may vary depending on for example, how closely the fibers are packed in each layer (ply) and/or the thickness of the continuous fibers. For example, if one were to use a continuous fiber such as NEXTEL 610 with 10,000 denier, the theoretical thickness (per ply) may be 0.0075 inch (190 mm) when fully consolidated. If one were to use the NEXTEL 610 continuous fiber with 3000 denier, the theoretical thickness (per ply) may be 0.005 inch (127 mm) when fully consolidated. The article made with the lower denier fibers may allow more design flexibility and possibly weigh less.

Typically, layers of fibers are positioned on top of each other to form a multi-layer prepreg. The fibers in the individual layers can be (and are preferred to be) oriented in specific directions relative to some reference axis, for example 0°, 90°, +45°, and −45°. The resulting article can have any combination of layers at various fiber orientations. The individual layers of fibers may be, for example, unidirectional monolayers of aligned rovings and/or fabric (e.g., woven or knitted fabric). After layering of the fibers and infiltrating with the polymer or layering prepreg material and consolidating/curing, the resulting multi-layer object is called a laminate and the individual layers are called lamina.

It is also within the scope of the present disclosure to have coatings on the fibers. Coatings may be used, for example, to enhance the wettability of the fibers, and/or to reduce or prevent reaction between the fibers and polymer. Such coatings and techniques for providing such coatings are known in the fiber art.

The polymeric composite comprises at least 30, 35, 40, 45, 50, 55, or 60% by volume and at most 55, 60, 65, or 70% by volume of continuous fibers in a polymeric material (herein referred to as a polymer and includes both copolymers (e.g, terpolymers, tetrapolymers, ect.) and homopolymers). While not wishing to be bound by any particular theory, it is presently believed that the polymer is used to provide structural continuity to the polymeric composite, to hold the continuous fibers in place, to transfer structural loads to the fiber reinforcement, and may be used to bond the polymeric composite to the monolithic ceramic. The polymer may also impact the residual compression stress applied to the monolithic ceramic based on the temperature at which the bonding of the monolithic ceramic to the polymeric composite occurs and the magnitude of temperature change during cooling after bonding or attaching. If the CTE of the polymeric composite layer is higher than the monolithic ceramic, compression is applied to the monolithic ceramic during cooling from the manufacturing process temperature. Finally, the magnitude of the residual compression stress induced may be proportional to the difference between the processing temperature and the use temperature. Therefore, a high bonding/curing temperature (for example, the processing temperature for PEEK composites is above 390° C.), may produce more residual compression than may be accomplished with other lower temperature bonding and attachment techniques such as conventional adhesive bonding (typically 80-200° C.).

Any polymer may be considered for use in the polymeric composite so long as it provides the functions as described above and does not negatively impact the residual compression applied to the monolithic ceramic. Exemplary polymers for the polymeric composite, as well as for bonding to the monolithic ceramic and additional layers together, include thermoplastics (i.e., plastics that soften and flow when heated and when cooled form a brittle glassy state), thermosets (i.e., plastics that are cross-linked that will not subsequently flow when heated), elastomers (i.e., amorphous polymers that are cross-linked), or combinations thereof. The polymeric composite comprises at least 25, 30, 35, or 40% by volume and at most 30, 40, 45, 50, 55, 60, or 65% by volume of the polymer.

Examples of suitable polymers include: epoxy, bismalimide, cynate ester, phenol-formaldehyde, urea-formaldehyde, polyester, polyurethane, polyvinyl ester, polycyanurate, diallyl phthalate, styrene block copolymer, polyethylene oxide, polyoxymethylene, polyamide, polyethylene terephthalate, polycarbonate, polyethylene, polypropylene, polyisobutylene, polypolymethylpentene, polybutadiene, polystryrene, polyvinyl chloride, polyvinylidene chloride, polytetrafluoroethylene, polyacrylonitrile, polyvinyl alcoholpolyaromatic esters, polyetherether ketone (PEEK), polyphenylene sulfide, or combinations thereof.

Examples of such polymers that are commercially available include: PEEK sold under the trade designation “VICTREX PEEK” by Victrex PLC, Greenville, S.C.; epoxy resins sold under the trade designations “NEWPORT 301” by Newport Adhesives and Composites, Inc, Irvine, Calif. and “HEXPLY 8552” by Hexcel Corp., Dublin, Calif.; modified bismaleimide resin sold under the trade designation “HEXFLOW® 651” by Hexcel Corp; and cyanate ester sold under the trade designation “BTCy-1” by TenCate Advanced Composites, Morgan Hill, Calif.

In one embodiment of this present disclosure, the polymer cures or solidifies at a temperature above 22° C. (72° F.), 121° C. (250° F.), 177° C. (351° F.), 232° C. (450° F.), or even 400° C. (752° F.).

The polymeric composite may also comprise additional components including, for example, at least one of: a metal (at least 25, 30, 35, 40, or 45% and at most 40, 45, or 50% by weight versus the polymer weight), a ceramic nanoparticle (at least 3, 5, 10, 15% and at most 10, 15, or 20% by weight versus the polymer weight), or a toughener (such as a thermoplastic or a rubber toughener) (at least 1, 2, 5, 10, or 12% and at most 5, 10, 15% by weight versus the polymer weight).

Suitable monolithic ceramics include at least one of: glasses, glass-ceramics, silicon carbide, boron carbide, alumina, boron nitride, titanium carbide, or combinations thereof. Suitable monolithic ceramic can be made by techniques known in the art and/or are commercially available (e.g., from Saint Gobain Ceramics & Plastics, Northboro, Mass., Ceradyne Inc., Costa Mesa, Calif., CoorsTek, Golden, Colo., and Technical Ceramics, Saint Albans, Vt.). In some embodiments according to the present disclosure, the article includes a monolithic ceramic layer, while in others the article includes a layer comprising an array of monolithic ceramic tiles. The tiles may be in any of a variety of shapes, including triangles, squares, rectangles, and other polygons (e.g., pentagon, hexagons, etc.). In some embodiments, the monolithic ceramic tiles may be positioned in a layer such that the tiles generally abut each other, while in others, the tiles may be position such that there is a small gap (e.g., 0.7 to 0.8, in some embodiments 0.75 mm) between them. Typically a filler material is placed in the gaps. The filler material may be, for example, an elastomer, a thermoset, or a polymeric composite such as fiber glass. Further, in some embodiments, the tiles may be positioned such that they overlap one or more tiles.

According to the present disclosure, the monolithic ceramic comprises at least two major surfaces and at least one minor surface. The major surface of the monolithic ceramic refers to the surface that is generally normal to the projectile (e.g., a bullet) impact and typically has a surface area greater than the at least one minor surface. The minor surface of the monolithic ceramic refers to the surface that is not generally normal to the projectile impact (e.g., an edge). In one embodiment, the polymeric composite is fixedly attached to a surface area of each of the at least two major surfaces that is substantially greater than the surface area of the at least one minor surface, where substantially greater is at least 1.5, 2, 4, 8, or even 10 times greater than the surface area of the at least one minor surface.

To prevent fracture from initiating at the minor surface (e.g., an edge) of the article, which is the point of highest residual stress and is generally the weakest point in the projectile impact direction, the polymeric composite may be fixedly attached to all surfaces of the monolithic ceramic, including the minor surfaces (e.g., edges), as depicted in FIG. 2. FIG. 2 is a schematic side view of exemplary article 20 according to the present disclosure. Exemplary article 20 comprises polymeric composite layers 22, 23, 24, and 25, fixedly attached to monolithic ceramic layer 32 with polymer 39. Polymeric composite layer 22 comprises continuous fibers 26a and 26b, and polymer 34, wherein continuous fibers 26a are offset 90° with respect to 26b. Polymeric composite layer 23 comprises continuous fibers 27a and 27b, and polymer 35, wherein continuous fibers 27a are offset 90° with respect to 27b. Polymeric composite layer 24 comprises continuous fibers 28a and 28b, and polymer 36, wherein continuous fibers 28a are offset 90° with respect to 28b. Polymeric composite layer 25 comprises continuous fibers 29a and 29b, and polymer 37, wherein continuous fibers 29a are offset 90° with respect to 29b. Polymeric composite layers 23 and 25 are wrapped around the edges of exemplary article 20, overlapping polymeric composite layers 22 and 24 as shown in FIG. 2.

In one embodiment, the polymeric composite fixedly attached to the at least two major surfaces is substantially symmetrical along a longitudinal bisection of the monolithic ceramic, in both thickness, and in the order of the layers. For example, the layers could be in the following order: the polymeric composition in the 0°, 90°, +45°, and −45° orientation, the monolithic ceramic, the polymeric composition in the −45°, +45°, 90°, and 0° orientation.

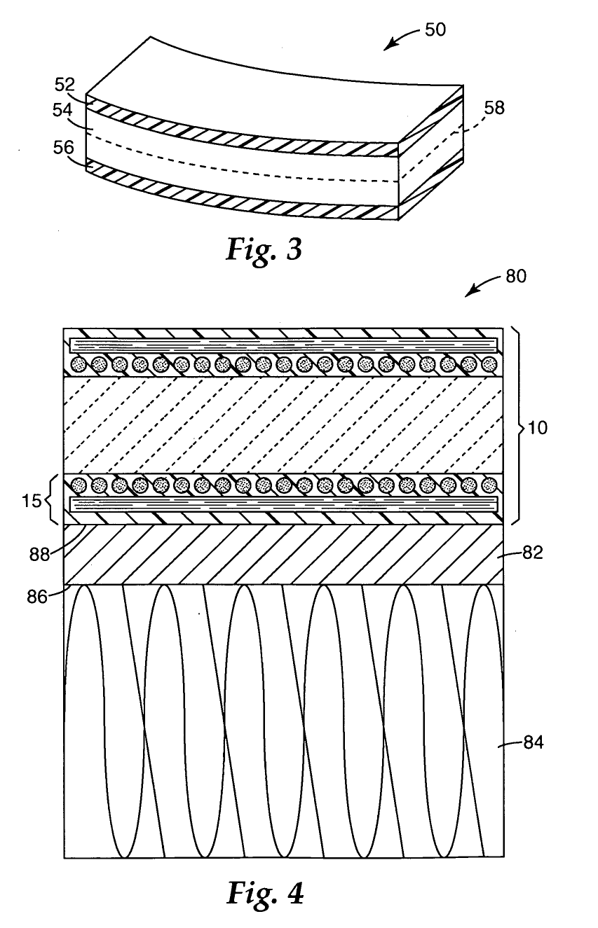

FIG. 3 depicts an exemplary article 50, which comprises polymeric composite 52 fixedly attached to the first major surface of a non-planar, monolithic ceramic 54 and polymeric composite 56 fixedly attached to the second major surface of the monolithic ceramic 52. The imaginary longitudinal bisection 58 is shown in FIG. 3, which bisects monolithic ceramic 54. In one embodiment of the present disclosure, the polymeric composite fixedly attached to the at least two major surfaces of the monolithic ceramic is substantially symmetrical along the longitudinal bisection of the monolithic ceramic. In one embodiment, the thickness of the polymeric composite fixedly attached to the at least two major surfaces is substantially the same (e.g., less than 10%, 5%, or even 1% different) along the longitudinal bisection of the monolithic plate so that the residual compression stress on the monolithic plate is substantially uniform through the thickness of the article, so as not to induce bending and causing the article to break.

In one embodiment, the monolithic ceramic is non-planar (e.g., as shown in FIG. 3). For example, the monolithic ceramic may have a 3-dimensional shape, such as Small Arms Protective Inserts (SAPI), Enhanced Small Arms Protective Inserts (ESAPI), and XSAPI. Therefore, it may be preferable or necessary for the substantially continuous fibers to be curved, as opposed to straight (i.e., do not extend in a planar manner). Hence, for example, the substantially continuous fibers may be planar throughout the fiber length, non-planar (i.e., curved, including compound curves) throughout the fiber length, or they may be planar at some portions and non-planar at other portions. In some embodiments, the substantially continuous fibers are maintained in a substantially non-intersecting, curvilinear arrangement (i.e., longitudinally aligned) throughout the curved portion of the polymeric composite layer. In some embodiments, the substantially continuous fibers are maintained in a substantially equidistant relationship with each other throughout the curved portion of the polymeric composite.

The fibers, pre-fabricated polymeric composite, and monolithic ceramic can be sized to provide the desired shape. For example, an elongated polymeric composite can be cut using conventional techniques such as with a wet saw or an abrasive cut-off saw.

Suitable polymeric composite can be can be made by techniques known in the art. It is also within the scope of the present disclosure to use both pre-fabricated and polymeric composite layers formed in situ. For example, continuous fibers may be layered with sheets of polymeric film and placed in direct contact with the monolithic ceramic. Upon heating, the polymeric film melts, filling in the interstitial spaces between the fibers and bonding the polymeric composite to the monolithic ceramic. Alternatively or additionally, a polymeric composite laminate may be made by prefabricating the continuous fiber in a polymer to form, for example, a prepreg. These prefabricated polymeric composite laminates may be made and then fixedly attached to the monolithic ceramic via adhesive or applying heat to bond the polymeric composite to the monolithic ceramic such as with a hot press or autoclaving.

Articles according to the present disclosure may be made by providing a monolithic ceramic comprising at least two major surfaces and at least one minor surfaces and a polymeric composite comprising at least one of continuous fibers that have an MCD of greater than 220,000 ((N/m2)/(g/mL))*(1/° C.); and fixedly attaching the polymeric composite to the at least two major surfaces wherein a surface area of each of the at least two major surfaces is substantially greater than a surface area of the at least one minor surface.

The articles according to the present disclosure may be manufactured using ordinary autoclave processing, resin transfer molding, or hot pressing to consolidate and cure the components. Alternatively the polymeric composites may be manufactured separately and then fixedly attached via adhesive, hot pressing, or autoclave processing.

Autoclave processing is advantageous because the monolithic ceramic rigidly defines the shape and may eliminate the need for hard tooling (such as that used to encapsulate ceramics with a metal matrix). Because only flexible pressure bags are needed to consolidate the polymeric composite against the monolithic ceramic, the tooling size can be easily varied to accommodate shape differences between parts, without the need and expense of creating a new mold. Also, because autoclaves are readily available having large oven dimensions (e.g., up to tens of feet in diameter) the size of a finished article (e.g., an armor panel) is not substantially limited.

The components for a particular article according to the present disclosure may be selected, for example, based on the anticipated end use and associated desired properties of the article. Typically, the article is designed to provide significant residual compression in the monolithic ceramic layer and to add constraint that reduces the size of the monolithic ceramic damage area. Although not wanting to be bound by theory, it is presently believed that this is achieved to some extent by placing polymeric composite layers on both major surfaces of the monolithic ceramic.

Typically, the collective thickness of the article (polymeric composite and monolithic ceramic) according to the present disclosure can be in a range from 0.25 inch (6.3 mm) to 2 inches (50.8 mm) (in some embodiments, for example, for body armor, in a range from 0.25 inch (6.3 mm) to 0.5 inch (12.7 mm) or, for example, for vehicle armor, in a range from 0.75 inch (19 mm) to 2 inches (50.8 mm)). Further, the thickness of articles according to the present disclosure that include a catcher, the thickness can be, for example, 1 inch to 1.5 inch (2.5 cm to 2.8 cm) for body armor, and 2.2 inches to 4 inches (6.4 cm to 10.2 cm) for vehicle armor.

In some embodiments of articles according to the present disclosure, the composition of the polymeric composite layers may be the same, while in others, one or more of the polymeric composite layers may be different (e.g., different polymers, different continuous fibers, different amounts of polymer and/or continuous fibers, etc.). Reasons for having differences in the polymeric composite layers may include creating greater residual compression on one major surface of the monolithic ceramic than the opposite, major surface of the monolithic ceramic.

Optionally, articles according to the present disclosure further comprise additional layers, features, etc. to further enhance their usefulness for a particular application. For example, it may be desirable for some applications to include metal matrix composite layers and/or additional monolithic ceramic layers, layers comprising an array of monolithic ceramic tiles, and/or metal layers.

Embodiments of articles described herein are particularly useful in abrading, fracturing, blunting, and/or deflecting a hard projectile and/or to resist the effects of a shaped charge explosive. FIG. 4 is a schematic side view of an exemplary article of armor. Exemplary armor 80, comprises exemplary article 10 according to one aspect of the present disclosure. Metal layer 82 is fixedly attached to adjacent second polymeric composite layer 15 with adhesive 88. Catcher 84 is fixedly attached to the adjacent metal layer 82 with adhesive 86.

In some applications, it may be desirable to include a metal (e.g., titanium) layer to provide energy absorption and to allow installation/attachment. Typically such a layer would be on a major side of the armor, opposite that which would be first impacted by a hard projectile, explosive charge, etc. The metal layers can be bonded to a metal, ceramic layer, or polymeric composite layer, as applicable, for example, using conventional adhesives for bonding such materials together (available, for example, under the trade designation “SUPER STRONG WEATHER STRIP ADHESIVE”, from 3M Co.). Other techniques for bonding the metal layer may include brazing, soldering, or diffusion bonding.

A separate energy and/or fragment catching layer (i.e., a catcher) positioned behind the polymeric composite/ceramic layers can further enhance the protective capability of the article against such effects. Exemplary materials for the “catcher” include fiber glass, aramid fiber, UHMW (ultra high molecular weight) polyethylene fiber (such as those marketed, for example, by DSM Dyneema, Geleen, Netherlands, under the trade designation “DYNEEMA”). In some embodiments, it may be desirable to use such materials as part of a composite. Layers of fabric or unidirectional fibers can be bonded to make a hard laminate. An exemplary hard laminate is marketed by DSM Dyneema as a “catcher”, under the trade designation “DYNEEMA HB 26”. The catcher can be bonded to a metal, a monolithic ceramic layer, a layer comprising an array of monolithic ceramic tiles, or a polymeric composite layer, as applicable, for example, using conventional adhesives for bonding such materials together (such as SUPER STRONG WEATHER STRIP ADHESIVE).

Because the strength of articles according to the present disclosure are high relative to the monolithic ceramic(s), the article may be incorporated into the structural design of the system they are protecting. For example, vehicles could benefit from removing parasitic armor (i.e., armor that serves only to protect and does not contribute to any other function), and replacing some of the structural panels with articles or articles comprising the same.

Additional uses for the articles according to the present disclosure include: hard plates or individual protective plates for individuals such as SAPI (small arms protective insert) plates, parasitic (no structural purpose) vehicle armor attached with bolts, hook-and-loop or welded, integral (structural and armor purpose) armor and protecting specialty items such as robots, equipment, or aircraft seats.

Various advantages and embodiments of this disclosure are further illustrated by the following examples, but the particular materials and amounts thereof recited in these examples, as well as other conditions and details, should not be construed to unduly limit this disclosure.

### Examples

Laminate 1 was prepared as follows. A prepreg made of ceramic fiber (10,000 denier) (sold under the trade designation “NEXTEL 610” by 3M Co.) and polyetherether ketone (PEEK, sold under the trade designation “VICTREX PEEK” by Victrex PLC, Greenville, S.C.) was manufactured by Phoenixx TPC, Inc., East Taunton, Mass. having a thickness of 0.0075 inches (190 micrometers) and having 62% by volume of ceramic fibers. The prepreg was cut into 4 inch (102 mm) squares. Between two parallel flat platens the following layers were stacked in order: aluminum foil (to prevent sticking/bonding to the platens); a 0.001 inch (0.025 mm) thick piece of polyimide film (to prevent bonding to the aluminum foil); six sheets of prepreg configured with the following orientation 0°/90°/+45°/−45°/90°/0°; polyimide film; and aluminum foil. The platens were then placed in a hot press and heated to 700° F. (371° C.) with a few thousand pounds of load. (Note: The processing temperature of 700° F. (371° C.) was below the desired processing temperature of 750° F. (400° C.), but was the maximum capability of the hot press at that time.) After the platens reached 700° F. (371° C.), the temperature and pressure were held for a few minutes, then the load was removed. After cooling to room temperature, the platens were opened and the dense laminate of PEEK/ceramic fiber was removed.

Laminate 2 was prepared as follows. The prepreg made by Phoenixx TPC, Inc. as described in Laminate 1 was cut into sheets measuring 2 inches (51 mm) wide and 4 inches (102 mm) long. Between two parallel flat platens the following layers were stacked in order: aluminum foil; polyimide film (0.001 inch (0.025 mm) thick); two sheets of the prepreg configured in alternating 0° and 90° orientation; polyimide film; and aluminum foil. The platens were then placed in a hot press and heated to 700° F. (371° C.) with a few thousand pounds of load. After the platens reached 700° F. (371° C.), the temperature and pressure were held for a few minutes, then the load was removed. After cooling to room temperature, the platens were opened and the dense laminate of PEEK/ceramic fiber was removed. The thickness of the dense laminate that was 0.02 inches (508 micrometers) thick.

Laminate 3 was prepared as follows. A ceramic fabric (8 harness satin weave of fibers with a 1500 denier roving and 27.5 rovings/inch in each direction) sold under the trade designation “3M NEXTEL WOVEN FABRIC 610 DF-11” by 3M Co. was cut into three squares measuring 4 inches×4 inches (10 cm (centimeters)×10 cm). A PEEK film (75 micrometers thick) sold under the trade designation “APTIV 1000” by Victrex PLC was cut into four squares measuring 4 inches×4 inches (10 cm×10 cm). Between two parallel flat platens the following layers were stacked in order: aluminum foil; polyimide film (0.001 inch (0.025 mm) thick); PEEK film, ceramic fabric; PEEK film; ceramic fabric; PEEK film; ceramic fabric; PEEK film; polyimide film; and aluminum foil. The platens were then placed in a hot press and heated to 750° F. (398° C.) with a few thousand pounds of load. The platens were held at 750° F. (398° C.) for 30 minutes, and then cooled to below 350° F. (177° C.) under load. The load was then removed and the platens were cooled to room temperature and then the dense laminate of PEEK/ceramic fiber was removed. Assuming the PEEK melted and infiltrated the ceramic cloth, the thickness of the dense laminate was calculated to be 0.0073 inches (190 micrometers) per sheet of ceramic fabric. The two polyimide release layers separated nicely from the aluminum foil, but bonded to the outside of the laminate, thus the finished laminate thickness included the 0.002 (50 micrometers) inches of polyimide film. The laminate measured 0.024 inch (610 micrometers) including the polyimide layers, which correlates with the predicted lamina thickness for each of the three ceramic fabric layers of 0.0073 inch (190 micrometers).

Example 1 was prepared as follows. A steel plate was placed atop a heated flat platen. Then, the following materials were stacked in the middle of the platen as follows: a sheet of aluminum foil; polyimide film (0.001 inch (0.025 mm) thick); Laminate 2 with the 90° orientation placed in direct contact with the polyimide film; a monolithic silicon carbide plate (0.15 inch (3.81 mm) thick by 2 inches (51 mm) wide, by 4 inches (102 mm); Laminate 2 with the 0° orientation placed in direct contact with monolithic silicon carbide plate; polyimide film; and aluminum foil. The two sheets of Laminate 2 were disposed in a symmetric orientation with respect to the monolithic silicon carbide plate. Another steel plate was placed on top of the aluminum foil. The assembly was placed in a hot press and internally heated to 700° F. (371° C.) while some load was maintained on the press (a few thousand pounds). After reaching 700° F. (371° C.), the platen heaters were turned off and the sample was allowed to cool to below 300° F. (150° C.) under load. The load was then removed and the platens were cooled to room temperature and the sample was removed. The sample appeared to be intact with no apparent cracking in the silicon carbide plate and no disbanding of the Laminate 1 on the surfaces was observed. The thickness of the sample was 0.19 inch (4.83 mm).

Example 1 then was struck with a hard blow with a ball peen hammer at 1 inch from the end and 1 inch from the side of the sample. After striking, Example 1 showed apparent cracking along the edges of the sample, but remained in one piece. Example 1 was struck again with a hard blow with the ball peen hammer on the opposite corner from the first blow, 1 inch from the end and 1 inch from side of the sample. After striking, Example 1 separated over half its length at the longitudinal plane (down the middle of the silicon carbide plate). Example 1 then was pried apart to examine the interior of the sample. Remarkably, although the silicon carbide plate cracked, the silicon carbide shards and fragments were fully bonded to Laminate 2. A small area (0.25 square inch) of Laminate 2 was debonded from one corner of the silicon carbide plate.

Example 2: A steel picture frame plate with an opening of an 8 inch (204 mm) square was placed atop a heated flat platen. Laminate 2 was cut into a 4 inch (102 mm) square. A 4 inch (102 mm) square monolithic silicon carbide plate (0.4 inches, 10.2 mm, thick) was used. In the center of the platen the following materials were stacked in the following order: aluminum foil; polyimide film (0.001 inch (0.025 mm) thick); Laminate 2 with the 90° orientation placed in direct contact with the polyimide film; the monolithic silicon carbide plate; Laminate 2 with the 0° orientation placed in direct contact with monolithic silicon carbide plate; polyimide film; and aluminum foil. Then, a sheet of Laminate 2 (4 inches (102 mm) long and 0.4 inches (10.2 mm) wide) was placed in direct contact with each of the four edges the monolithic silicon carbide plate. The 0° orientation of Laminate 2 was placed in direct contact with the monolithic silicon carbide plate. Aluminum spacers (4 inches (102 mm) wide) were placed between the steel picture frame plate and Laminate 2 to hold the polymeric composite near the monolithic silicon carbide plate. Because the aluminum spacers have a higher coefficient of expansion than steel, as the temperature is raised, the aluminum spaces will keep the polymeric composite in contact with the monolithic ceramic to facilitate bonding of the polymeric composite to the monolithic ceramic. Aluminum foil and polyimide film was used between the aluminum spacers and Laminate 2. Another flat platen was placed on top of the steel frame and layered sample. The two parallel flat platens were placed in a hot press and internally heated to 700° F. (371° C.) while some load was maintained on the press (a few thousand pounds). After reaching 700° F. (371° C.), the platen heaters were turned off and the sample was allowed to cool to below 300° F. (150° C.) under load. The load was then removed and the platens were cooled to room temperature and the sample was removed.

Example 3 was prepared as follows. Example 3 was prepared similarly to Example 2, except that Laminate 1 was used and a monolithic alumina plate (0.5 inch (12.7 mm) thick by 4 inches (102 mm) by 4 inches (102 mm)) was used. Sheets of Laminate 1 used for the sides were cut accordingly to match the thickness of the monolithic alumina plate and Laminate 1 was layered accordingly to ensure symmetry around the monolithic alumina plate.

### Prophetic Example 1

A SAPI tile (such as one obtained from Ceradyne Inc., Costa Mesa, Calif. or CoorsTek, Golden, Colo., Saint Gobain Ceramics & Plastics, Northboro, Mass.) may be projected to a flat-pattern and a NEXTEL/PEEK prepreg may be cut to the flat-pattern. Two layers of prepreg may be cut for each side in the 0° and 90° orientations. A hot press or another method may be used to preconsolidate the 0° and 90° orientations of the prepregs to the approximate shape of the SAPI plate and to consolidate the prepregs so that they hold their shape.

The laminates may be placed in front and in back of the SAPI plate, making sure the laminate is in the same orientation on either side of the SAPI plate. Then the layered sample may be placed in a vacuum bag, placed in an autoclave, and heated at 380-400° C., 1 MPa pressure, for 30 minutes. The load may be removed and the samples may be cooled to room temperature.

### Prophetic Example 2

Prophetic Example 2 may be made similar to Prophetic Example 1, except that after placing the laminates in front and in back of the SAPI plate, an edge support may be added. These edge supports may be made by building a tooling that allows U-Shaped laminates to be produced such as those depicted in FIG. 2. These laminates may be slipped over the edges and extend inward about one-fourth inch to one inch. After enough of these pieces have been applied to fully enclose all the edges, the sample then may be placed in a vacuum bag, autoclaved, and cooled as described in Prophetic Example 1.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term ‘about’. Various exemplary embodiments have been described. These and other embodiments are within the scope of the following claims.

What is claimed is:

1. An article comprising:
a monolithic ceramic comprising at least two major surfaces and at least one minor surface; and
a polymeric composite comprising at least one of continuous fibers that have an MCD of greater than 220,000 ((N/m2)/(g/mL))*(1/° C.),
wherein the polymeric composite is fixedly attached to the at least two major surfaces and the polymeric composite is fixedly attached to a surface area of each of the at least two major surfaces that is substantially greater than a surface area of the at least one minor surface.

2. An article according to claim 1, wherein the polymeric composite comprises the at least one of continuous fibers in a polymer wherein the polymer cures or solidifies at a temperature above 22° C.

3. An article according to claim 2, wherein the polymer is at least one of a thermoplastic or a thermoset.

4. An article according to claim 1, wherein the monolithic ceramic is non-planar.

5. An article according to claim 1, wherein the polymeric composite fixedly attached to the at least two major surfaces is substantially symmetrical along a longitudinal bisection of the monolithic ceramic.

6. An article according to claim 1, wherein the polymeric composite is fixedly attached to all surfaces of the monolithic ceramic.

7. An article according to claim 1, wherein the polymeric composite is bonded to the monolithic ceramic.

8. The article according to claim 1, wherein the monolithic ceramic comprises at least one of: silicon carbide, boron carbide, alumina, boron nitride, titanium carbide, or combinations thereof.

9. The article according to claim 1, wherein the monolithic ceramic further comprises a crystalline ceramic.

10. The article according to claim 1, wherein the monolithic ceramic further comprises an array of monolithic ceramic tiles.

11. The article according to claim 1, wherein the at least one of continuous fibers comprise at least one of: ceramic, boron, or combinations thereof.

12. The article according to claim 1, further comprising a catcher.

13. The article according to claim 1, further comprising a metal layer.

14. The article according to claim 13, further comprising a catcher.

15. A method of making an article comprising:
providing a monolithic ceramic comprising at least two major surfaces and at least one minor surfaces and a polymeric composite comprising at least one of continuous fibers that have an MCD of greater than 220,000 ((N/m2)/(g/mL))*(1/° C.); and
fixedly attaching the polymeric composite to the at least two major surfaces wherein a surface area of each of the at least two major surfaces is substantially greater than the surface area of the at least one minor surface.

16. A method of making an article according to claim 15 further comprising at least one of hot pressing or autoclaving to fixedly attach the polymeric composite to the at least two major surfaces.

17. A method of making an article according to claim 15, wherein the polymeric composite comprises continuous fibers in a polymer wherein the polymer cures or solidifies at a temperature above 22° C.

18. A method of making an article according to claim 15, further comprising fixedly attaching the polymeric composite with the at least one minor surface.

19. A method of making an article according to claim 15, wherein the polymeric composite is fixedly attached with all surfaces of the monolithic ceramic.

20. A method of making an article according to claim 15, wherein the at least one of continuous fibers are selected from at least one of: ceramic, boron, or combinations thereof.
